(19) United States
(12) Patent Application Publication
(10) Pub. No.: US 2008/0217946 A1
(43) Pub. Date: Sep. 11, 2008

(54) Linkage Slide-Out Mechanism for a Vehicle

(76) Inventors: Michael D. Kobrehel, Elkhart, IN (US); Jeffrey D. Mikenas, Valparaiso, IN (US)

Correspondence Address: QUARLES & BRADY LLP, 411 E. WISCONSIN AVENUE, SUITE 2040, MILWAUKEE, WI, 53202-4497, US

(21) Appl. No.: 12/043,336

(22) Filed: Mar. 6, 2008

Related U.S. Application Data
(60) Provisional application No. 60/893,287, filed on Mar. 6, 2007.

(51) Int. Cl. B60P 3/34

(52) U.S. Cl. 296/26.13

(57) ABSTRACT

Side-mounted linkage slide-out mechanisms move a slide-out section of a vehicle linearly from a retracted position within an interior of the vehicle to an extended position outward of the vehicle interior. Pivotal scissor linkage assemblies are driven by a linear actuator to pivot about one or more moving pivots mounted to the slide-out section and one or more stationary pivots mounted to the vehicle, and thereby translate the slide-out section. The linkage and drive components have features that limit travel and lock out movement of the slide-out section upon reaching the fully retracted and extended positions.

### CROSS-REFERENCE TO RELATED APPLICATIONS

This application claims benefit to U.S. Provisional Application No. 60/893,287, filed Mar. 6, 2007.

### STATEMENT OF FEDERALLY SPONSORED RESEARCH OR DEVELOPMENT

Not applicable.

### BACKGROUND OF THE INVENTION

1. Technical Field

The present invention relates to vehicles having expandable room sections, and more particularly to an improved mechanism for moving slide-out sections between extended and retracted positions relative to the vehicles.

2. Description of the Related Art

In order to increase the available interior space, recreational vehicles or trailers can have rooms, closets and other sections that slide out from the interior of the vehicle when it is parked. During transit, these sections are retracted and stored in the interior of the vehicle or trailer, with the exterior wall of the slide-out section being essentially flush with the exterior of the vehicle or trailer. After the vehicle or trailer is parked and leveled, the slide-out section can be slid outward from the vehicle using various manual or powered drive systems, with the motive force being provided by hydraulics, pneumatics, electric motors, drive screws, gear mechanisms, pulley arrangements, or various combinations thereof.

Slide-out drive systems provide two separate functions, namely, to extend and retract the section and to provide adequate compression of the seals at the opening surrounding the section to eliminate environmental intrusion. Slide-out drive systems have three basic operating arrangements, namely, linear movement, non-linear movement and combinations thereof.

Conventional linear movement drive systems generally have the disadvantage of requiring substantial room for packaging above and/or below the slide-out section, requiring integration into the vehicle's structural frame and/or roof area. This can be costly, inefficient and labor-intensive. The very nature of some linear movement drive systems, such as underside mounted rack/cylinder arrangements, require that the total length of the drive components to exceed the total distance that the room slides out, thereby further complicating packaging of the drive system. These underside mounted systems reduce the clearance of the vehicle and typically add considerable weight to the vehicle in that large robust rails are typically used that can support the weight of an extended section and its occupants.

Conventional non-linear drive systems have shortcomings as well. Drive systems with cable and pulley arrangements impart movement to the slide-out section in a non-direct, see U.S. Pat. Nos. 6,623,066 and 6,644,719. To allow the cable to pull the room back into the vehicle it is typically connected to the outer four corners of the section, and either run partially or complete outside of the side walls. When the cable exits the outside of the vehicle and/or slide-out section, it exposed to sight and environment, which can be unappealing aesthetically and compromise the seals or gaskets through which they pass that are designed to seal out the environment.

Other non-linear movement drive systems, such as disclosed in U.S. Pat. Nos. 5,857,733 and 5,800,002 use complex kinematics to “swing” or “swing & slide.” Such systems may require a guide to transfer the non-linear movement into the linear direction. Or, as shown in U.S. Pat. No. 5,822,921, the force can be transferred by a sash joint, however, the joint introduces a point of friction and inefficient movement that may bind the system or provide unwanted tolerance stack up by its very nature and cause the movement to be un-aligned or aligned less than conventional direct linear movement systems. This can cause one side of the room to reach full travel before the other side, and thereby effect sealing and potentially causing the slide-out to jam. Direct drives, mechanically tied together systems, or systems which use one common drive (or one common power source as in dual electrical motors controlled by one controller) may not account for this variation during cycling or over the life of the product.

Some slide-out drive systems use a combination of linear actuator that imparts non-linear motion to the drive assembly which in turn slides the section linearly. For example, U.S. Pat. No. 6,533,338 discloses a vertical arm mechanism for extending and retracting a vehicle slide-out section. This mechanism uses a hydraulic cylinder to retract and extend a large folding arm that is hinged in the middle. The arm folds and extends in a vertical plane to a side of the slide-out section under the force of the hydraulic cylinder. The hinge is comprised of mating cams that allow the slide-out section to lie above the vehicle floor when retracted and then drop down to be generally flush with the vehicle floor when extended. This folding arm mechanism is rather large and thus occupies significant space between the slide-out section and the vehicle thereby reducing available interior space. It is also heavy and requires significant force to extend and retract.

It is also important for the slide-out sections to be held securely in both the extended and retracted positions, and to limit travel of the moving components when these positions are reached. Travel stops are known generally to lock the section after it has been retracted. Mechanical locks, electrically powered solenoids and the like can be used for this purpose. However, conventional travel stops are disadvantageous for several reasons. For instance, they may lock movement of the section in one direction or in only the fully or retracted position. They may also be separate, discreet components that create costs and space requirements in addition to that of the drive system. Conventional travel locks may also require active deactivation or positive release prior to operation of the drive system in order not to interfere with normal movement of the drive components, thus requiring synchronization between the travel lock and the drive components.

Accordingly, an improved mechanism for extending and retracting a slide-out section of a vehicle is needed.

### SUMMARY OF THE INVENTION

The present invention is an actuation mechanism for moving a slide-out section of a vehicle between extended and retracted positions. The mechanism can be mounted in the space between the vehicle and one or more of the vertical sides of the slide-out section. The mechanism can have a pivoting linkage assembly driven by a powered actuator, and it can be self-limiting so as to prevent movement of the slide-out section beyond the fully extended and retracted position and to lock the slide-out section after reaching those positions.

Specifically, the present invention provides a slide-out mechanism for moving a slide-out section of a vehicle from a retracted position within an interior of the vehicle to an extended position outward of the vehicle interior. The slide-out mechanism has a pair of first and second pivots, a drive actuator and a linkage assembly. One pivot is mounted to the slide-out section to move therewith and the other is mounted to the vehicle and thus stationary. The drive actuator is mounted to either the slide-out section or the vehicle and is coupled to the linkage assembly. The linkage assembly has a drive link pivotally coupled to the first pivot and to a pivot link. The pivot and drive links can be coupled at a third pivot that travels as the links are pivoted in a path different from, and preferably perpendicular to, the path travel by the slide-out section. The pivot link is pivotally coupled to the second pivot. The drive actuator drives the drive link to pivot about the first pivot so that the linkage assembly drives the slide-out section to slide between the extended and retracted positions relative to the vehicle.

Of the various configurations that the slide-out mechanism can take within the scope of the invention, in one configuration the first pivot and the drive actuator are mounted to the vehicle and the second pivot is mounted to the side wall of the slide-out section. The drive actuator can be a linear actuator having a linearly moveable drive member pivotally mounted with respect to the drive link.

In other configurations, the linkage assembly can have a second pair of pivots vertically spaced from the first pair, for example so that one pair is near the top of the slide-out section and the other pair is near the bottom, thereby distributing the sliding force to each side of the horizontal centerline of the slide-out section. In that case, there can be one or more tie links and a pair of follower drive and pivot links pivotally coupled together and to an associated one of the second pair of pivots. Pivotal movement of the drive and pivot links is transferred to the follower drive and pivot links by the tie link(s), which is pivotally coupled to the drive and pivot links at one end and to the follower drive and pivot links at the other end.

In other configurations, one of the links (e.g., the pivot link) has a catch fixedly mounted to move therewith. A pivot block is fixedly mounted to the other link (e.g., the drive link) to move therewith. A drive pivot is pivotally coupled to the drive actuator and the pivot block. The drive pivot engages the catch at a predetermined pivot angle between the drive and pivot links to prevent relative pivoting of the drive and pivot links beyond the predetermined pivot angle, which can correspond to a fully extended position of the slide-out section. The drive pivot has a lever member that physically abuts the catch when the drive and pivot links are at the predetermined pivot angle. The pivot block has a retainer that allows relative movement of a mating feature of the drive pivot when the its link is pivoted in one direction and fixes the position of the mating feature as that link is pivoted in the opposite direction. A spring operatively mounted between the pivot block and the drive pivot bias against pivoting of the drive pivot. The catch extends essentially perpendicularly from its link.

The linkage assembly can also have a travel stop to permit pivoting of the linkage assembly to drive the slide-out section between fully retracted and extended positions, but prevent relative pivoting of the drive and pivot links beyond that corresponding to one of the fully retracted and extended positions of the slide-out section. The drive and pivot links can be essentially co-linear when the slide-out section is fully retracted (or extended), and the travel stop prevents further pivoting of the linkage system by physically abutting at least one, and preferably both, of the drive and pivot links so as to interfere with further pivotal motion thereof.

There can also be two slide-out mechanisms used to move the slide-out section, including a second pair of first and second pivots, a second drive actuator and a second linkage assembly. The two mechanisms can be arranged in mirror image at opposite lateral side walls of the slide-out section or at its top and bottom.

The advantages of the invention will be apparent from the detailed description and drawings. What follows is are preferred embodiments of the present invention. To assess the full scope of the invention the claims should be looked to as the preferred embodiments are not intended as the only embodiment within the scope of the invention.

### BRIEF DESCRIPTION OF THE DRAWINGS

FIGS. 1 and 2 are simplified partial perspective views showing a vehicle slide-out room in respective retracted and extended positions;

FIG. 3 is a partial perspective view of one (left side) scissors slide-out mechanism according to the present invention for extending and retracting the slide-out room, the scissors slide-out mechanism shown in the position with the room retracted;

FIG. 4 is a partial top section view showing left and right side scissors slide-out mechanisms of the preferred embodiment described herein;

FIG. 5 is a partial front sectional view showing the left side scissors slide-out mechanism;

FIG. 6 is a partial side sectional view thereof when the slide-out room is retracted;

FIG. 7 is an enlarged partial side sectional view showing a linear actuator and pivot arrangement thereof;

FIG. 8 is a partial side sectional view thereof when the slide-out room is extended; and

FIG. 9 is a partial interior perspective view of one (left side) scissors slide-out mechanism according to another embodiment of the present invention in the position with the room retracted.

### DETAILED DESCRIPTION OF THE PREFERRED EMBODIMENTS

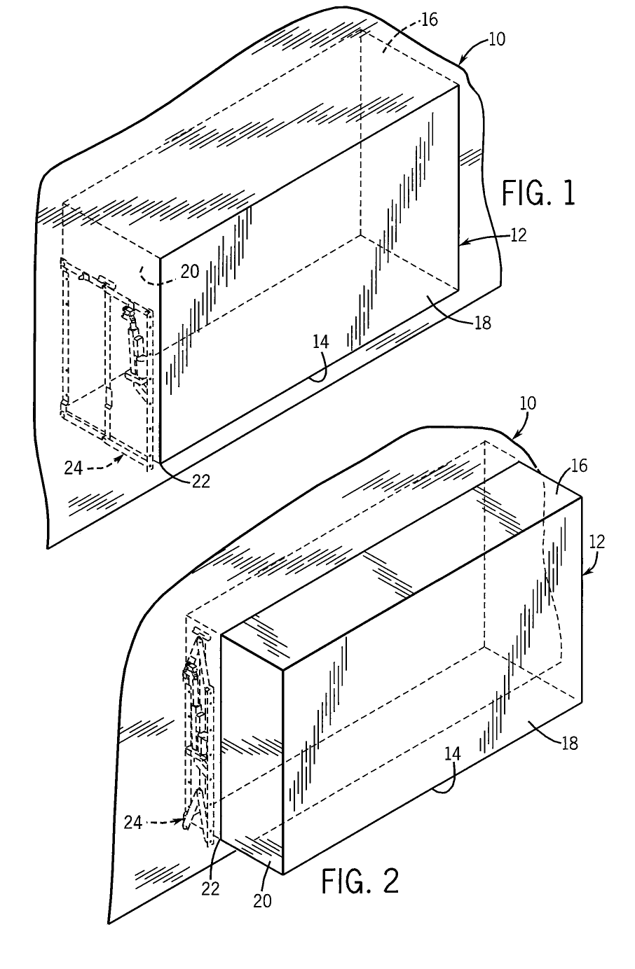

FIGS. 1 and 2 of the drawings illustrate schematically a vehicle 10, such as a tow-along (trailer) or a self-propelled (motorhome) recreational vehicle, having a slide-out section 12. The slide-out 12 section, as known in the art, can be a room, closet, wardrobe or other section that is generally disposed within the interior of the vehicle 10 when retracted and outward of the vehicle interior when extended. The slide-out section 12 is supported by the a frame assembly of the vehicle 10, such as a pair of upright side support tubes, one at the outside of each side of the slide-out section 12, and a lateral support tube extending between the side support tubes beneath the slide-out section 12.

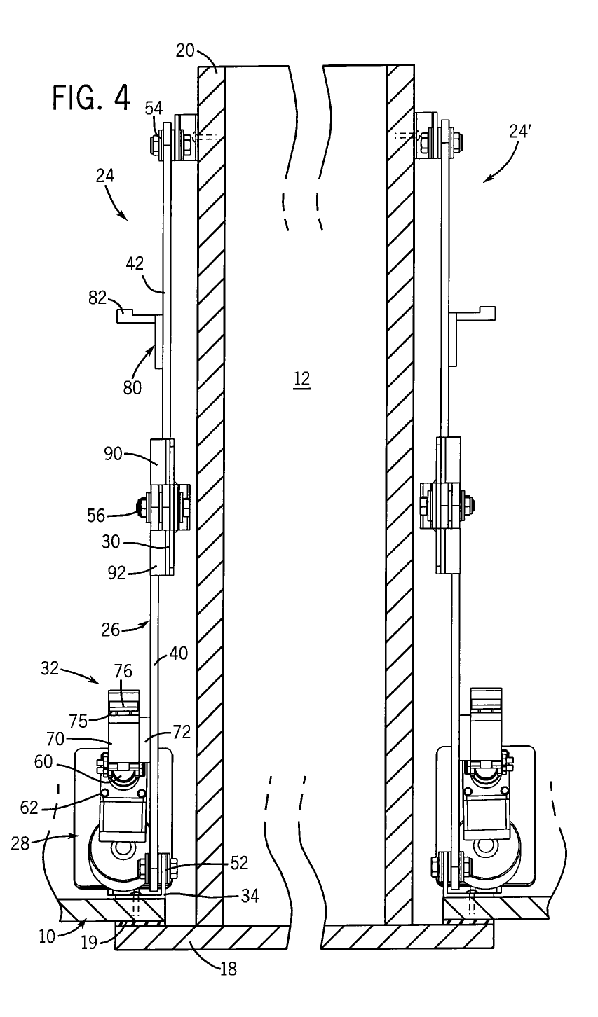

The slide-out section 12 can have a floor 14, a ceiling 16, an upright end wall 18 and two upright side walls 20. The end wall 18 closes off an opening 22 in the vehicle 10, and generally serves as a part of the exterior side of the vehicle 10 when the slide-out section 12 is retracted. The end wall 18 has a periphery sized larger than the opening 16 in the vehicle 10 allowing a place for one or more seals 19 (see FIG. 4) to seat and seal of the interior of the vehicle. The end 18 and side 20 walls are preferably insulated and suitable for exterior exposure.

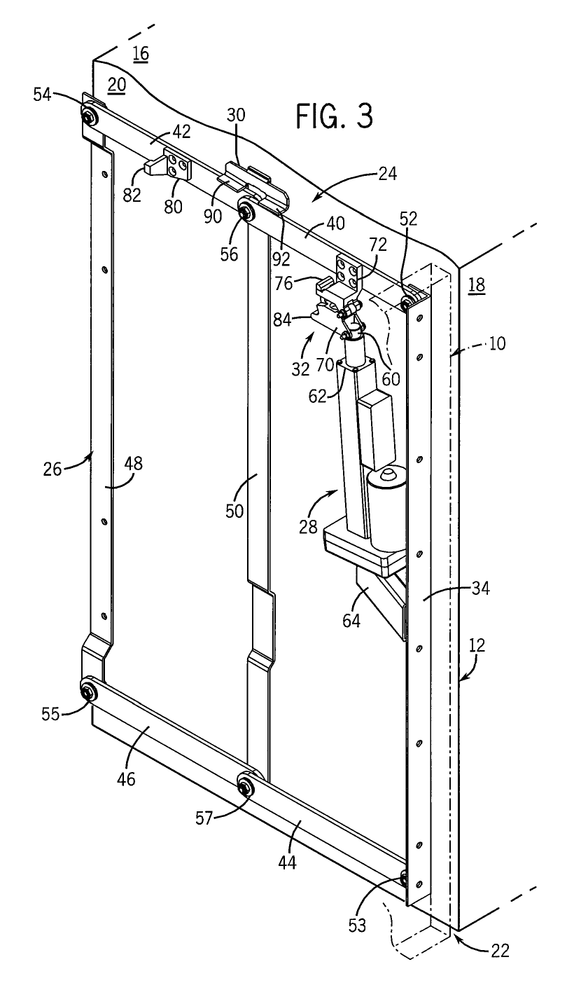

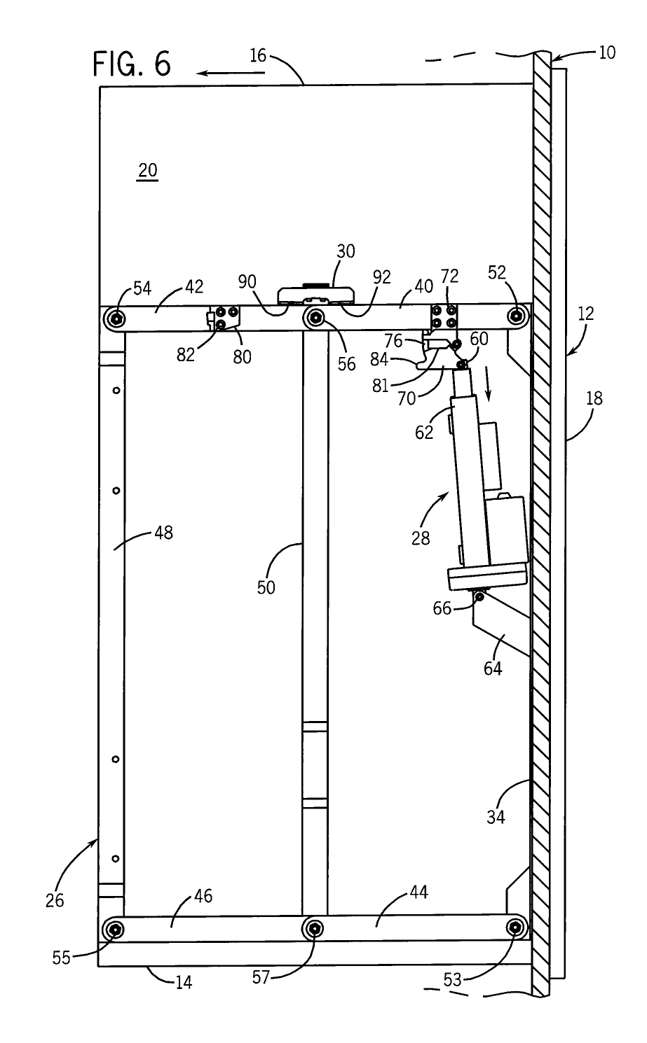

FIG. 1 shows the slide-out section 12 in a fully retracted position in which it is primarily disposed in the interior of the vehicle 10. FIG. 2 shows the slide-out section 12 in a fully extended position in which it is moved outwardly to clear the fixed interior space of the vehicle 10. FIGS. 1 and 2 also show schematically one slide-out mechanism 24 (in phantom) used to extend and retract the slide-out section 12. FIGS. 3 and 6 illustrate the slide-out mechanism 14 when the slide-out section 12 is retracted, and FIG. 8 illustrates the slide-out mechanism 24 when the slide-out section 12 is extended.

While only one slide-out mechanism is shown in many of the figures, the slide-out mechanism 24 is preferably one of two such mechanisms 24 and 24′ shown in FIG. 4) that are identical, but assembled as mirror images and mounted to each lateral side of the slide-out section 12 so as to mount the slide-out section 12 to the vehicle 10 at the opposite side walls 20. To simplify the discussion herein, only the left slide-out mechanism 24 shown in FIGS. 1 and 2 will be discussed in detail. However, it should be noted that suitable control measures should be taken to ensure that both mechanisms 24 and 24′ are driven at the same rate so that both lateral sides of the slide-out section 12 travel an essentially uniform distance, thereby preventing binding of the slide-out section 12 as it is extended and retracted.

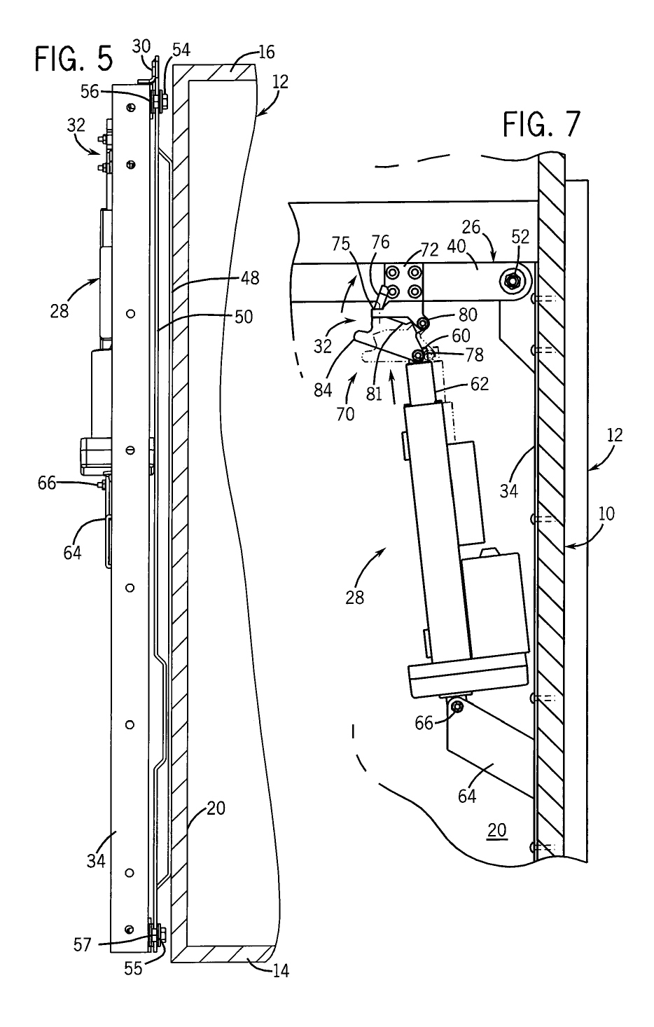

Referring to FIGS. 3-8, the slide-out mechanism 24 has as major components a linkage assembly 26, a drive actuator 28 and traveling stop and locking arrangements 30 and 32.

The slide-out mechanism 24 either has or mounts to an upright member 34 fixedly mounted to structural members of the vehicle 10 so as to be supported to the lateral side of the slide-out section 12. The linkage assembly 26 includes a drive link 40, a pivot link 42, a follower drive link 44, a follower pivot link 46, a fixed tie link 48 and a traveling tie link 50. The links 40-50 are coupled together at pivots including a pair of stationary pivots 52 and 53, fixed pivots 54 and 55 and traveling pivots 56 and 57. The stationary pivots 52 and 53 are mounted to the vehicle via the upright member 34 and do not change position during operation of the slide-out mechanism 24. The fixed pivots 54 and 55 are secured to the vertical side wall of the slide-out section 12 and move along with the slide-out section 12 as it is extended and retracted. The traveling pivots 56 and 57 are not mounted to, and thus free to move relative to, the slide-out section 12 and the vehicle. The traveling pivots 56 and 57 travel in a path that is generally perpendicular to the travel path of the slide-out section 12. By the fixed pivots 54 and 55 being mounted to the slide-out section 12 and the stationary pivots 52 and 53 being mounted to the vehicle, the linkage assembly 26 serves to join the slide-out section 12 to the vehicle and transmits input drive forces to provide relative movement. Ends of the drive 40 and follower drive 44 links are coupled to the stationary pivots 52 and 53, and their opposite ends are coupled to the pivot 42 and follower pivot 46 links via the traveling pivots 56 and 57, which are coupled to opposite ends of the fixed tie link 48 at the fixed pivots 54 and 55, respectively. The traveling tie link 50 couples the traveling pivots 56 and 57. The tie links 48 and 50 thus transfer drive forces to the follower links and thereby to the lower end of the slide-out section 12. This aids in achieving uniform travel of the top and bottom ends of the slide-out section 12 between extended and retracted positions and prevents binding of the slide-out section 12.

All of the pivots 52-57 allow for pivotal movement of the associated link(s). In particular, the links of the linkage assembly 26 pivot from the position shown in FIG. 6, in which the slide-out section 12 is fully retracted, to that shown in FIG. 8, in which the slide-out section 12 is fully extended. For the slide-out mechanism 24 shown in FIG. 3 (at the left side of the slide-out section 12), when moving from the FIG. 6 to the FIG. 8 positions, the drive 40 and drive follower 44 links pivot about the stationary pivots 52 and 53 in a clockwise direction to drive the traveling pivots 56 and 57 upwardly and thereby pivot the pivot 42 and follower pivot 46 links in a counter-clockwise direction about the fixed pivots 54 and 55, respectively. The slide-out section 12 is constrained from rotation within the opening of the vehicle and thus the linear force component associated with the pivotal movement of the linkage assembly 26 transfers a linear, or translating sliding motion to extend the slide-out section 12. The force component of the opposite pivotal motion of the linkage system 26 causes linear sliding motion to retract the slide-out section 12.

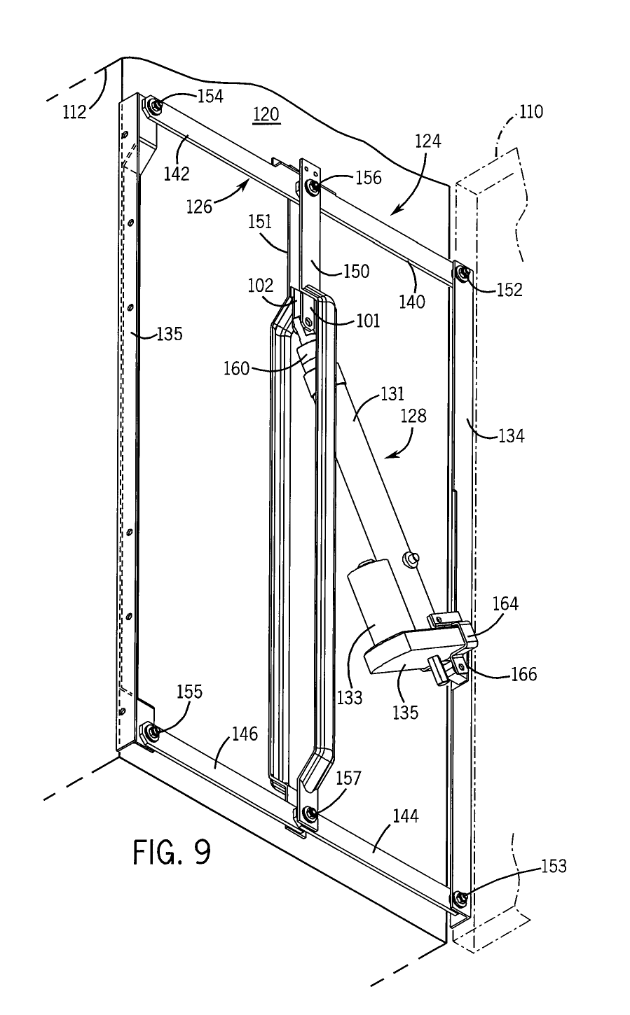

The force input to the linkage assembly 26 for moving the slide-out section 12 is provided by the drive actuator 28. The drive actuator is preferably a linear actuator having piston or plunger actuator member 60 that moves linearly in and out of its cylinder 62. A conventional hydraulic cylinder and associated hydraulics flow control hardware can be used. If hydraulic cylinders are used when there are two slide-out mechanisms 24 and 24′, as shown in FIG. 4, the cylinders may be plumbed in a simple parallel hydraulic circuit or may be supplied by a flow divider circuit. Such a flow divider circuit is disclosed in FIG. 9 of U.S. Patent Application Publication No. 2006/0163859, the disclosure of which is hereby incorporated by reference. An air cylinder may also be used provided sufficient operational forces can be achieved. In either case, the cylinder must be able to apply both push and pull linear forces. The drive forces can generally range from 100-1,000 lbs depending upon the size and construction of the slide-out section and the location of coupling of the drive actuator. The slide-out sections typically range between 350-1,500 lbs. The drive actuator 28 is mounted at one end to the vehicle member 34 via bracket 64, which has a pin connection 66 allowing the drive actuator 28 to pivot. The actuator member 60, at the other end of the drive actuator 28, pivotally couples to the drive link 40 via the locking arrangement 32. Thus, while the working actuator member 60 of the drive actuator 28 moves only in a linear path, the drive actuator 28 is able to pivot with respect to both the vehicle and the linkage assembly 26.

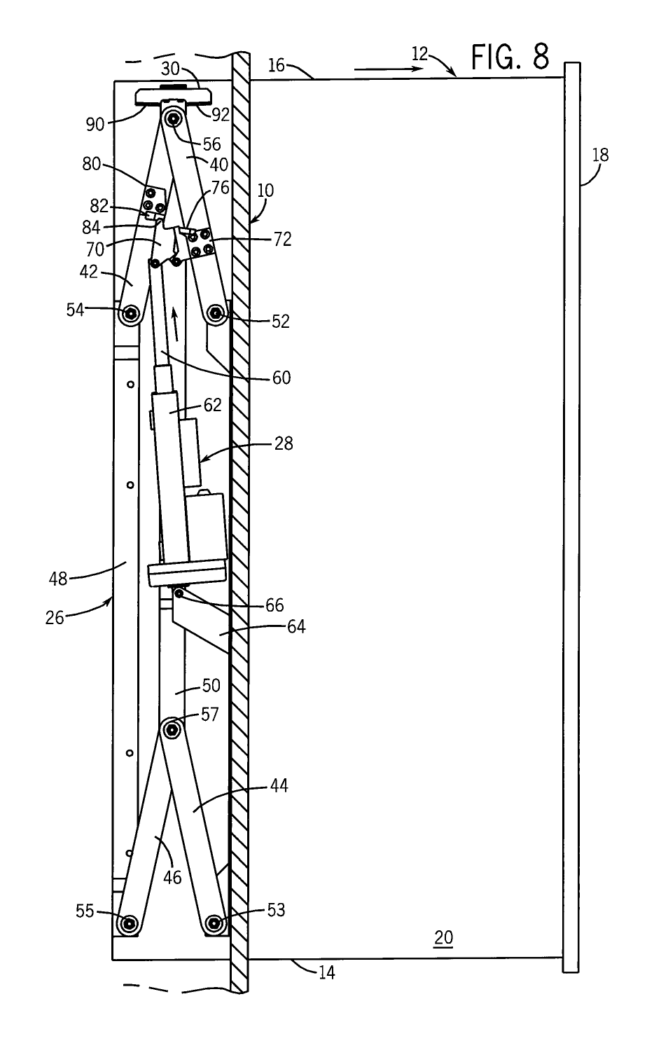

The locking arrangement 32 includes a drive pivot 70, a pivot block 72 and a catch 74. The pivot block 72 is fixedly mounted to the drive link 40 to move therewith. It is an angled L-shaped piece in which one leg is mounted to the drive link 40 and the other leg extends out generally perpendicularly with respect to the plane of the drive link 40. That extending leg has channel for receiving the stem of a T-shaped member 76 of the drive pivot 70, which serves to couple the drive pivot 70 to the pivot block 72, and thereby the drive actuator 28 to the drive link 40, with a range of relative movement therebetween. The drive pivot 70 is pivotally mounted to the free end of the actuator member 60 via a pin connection 78 and is also pivotally mounted to the pivot block 72 via another pin connection 80. The drive pivot 70 thus can pivot with respect to the both the drive actuator 28 and the drive link 40 as it pivots through a prescribed angle or rotation, as described below. A high spring rate compression spring 81 is disposed between the drive pivot 70 and pivot block 72 to bias the drive pivot 70 away from the pivot block 72 (in a counter-clockwise direction about pin connection 78 when viewed as shown in FIG. 7) so that the T-shaped member 76 is biased in abutment with the pivot block 72. The free end of the drive pivot 70 has a projecting lever 84 extending therefrom that engages the catch 74, as described below. The catch 74 is fixedly mounted to the pivot link 42 to move therewith. The catch 74 bolts to the pivot link 42 and extends out generally perpendicularly with respect to the plane of the pivot link 42. The free end of the catch has a hook end 82 extending essentially parallel with the pivot link 42.

The operation of the locking arrangement 32 will now be described. As the drive actuator 28 drives the linkage assembly 26 so that the slide-out section 12 moves to its fully extended position, the seals and frame of the vehicle 10 come into contact with the slide-out section 12 stop to stop further extension travel. At that point, the linkage assembly 26 is in the position shown in FIG. 8, and the drive actuator 28 continues linear movement of the actuator member 60 to load the spring 81. The spring 81 does not compress immediately from the travel of the slide-out section 12 due to its high spring force (such as 50-150 lbs), however, the additional force applied by the drive actuator 28 forces the drive pivot 70 to compress the spring 81 and thereby come in contact with and transfer forces to the pivot block 72 as it pivots about pin connection 80 (clockwise in FIG. 8). At this point, which corresponds to a predetermined angle of pivot, the lever 84 of the drive pivot 70 also contacts the catch 74 so that the drive link 40 and pivot link 42 are effectively linked together at two points, namely, the pivot 56 and the engagement of the lever 84 and catch 74. This effectively locks the linkage assembly 26 in a rigid assembly when in the condition, and thus prevents pivoting of the links in an extension direction beyond the predetermined pivot angle α shown in FIG. 8, and thereby locks the position of the slide-out section 12

When the drive actuator 28 drives the actuator member 60 in the opposite direction to retract the slide-out section 12, the spring 81 decompresses and the drive pivot 70 rotates back about the pin connection 80 to disengage the lever 84 from the catch 74, thereby freeing movement of the linkage system 26 to retract the slide-out section 12. The cross-bar of the T-shape member 76 re-contacts the pivot block 72 so that the pulling force from the drive actuator 28 is transferred from the drive pivot 70 to the pivot block 72 to the drive link 40 and the rest of the linkage assembly 26.

Thus, in one direction the drive actuator 28 “over strokes” to the predetermined angle a where the spring 81 is compressed to force the drive pivot 70 and the pivot block 72 together, and lock the linkage assembly 26. In the opposite direction, the drive pivot 70 and pivot block 72 are pulled apart as the drive block pivots about the pin connection 80, albeit while remaining interlocked via the T-shaped member 76 to transmit forces for effecting pivoting of the linkage system 26.

In addition to the locking arrangement 32, the slide-out mechanism 24 includes a travel stop 30. The travel stop 30 is a short, rigid member that is part of, or mounts to, the traveling tie link 50 and extends to generally perpendicularly to the length of the tie link 50 to each side of the tie link 50 in the direction of extension and retraction of the slide-out section 12. In the embodiment shown in the figures, the travel stop 30 just above the drive 40 and pivot 42 links, however it could be located just above the follower drive 44 and follower pivot 46 links. In any event, the travel stop 30 has two tabs 90 and 92 that extend perpendicular to the planes of the links. As shown in FIGS. 6 and 8, the travel stop 30 travels with the linkage assembly 26 and stays in a constant orientation with respect to the traveling tie link 50 through the range of motion of the linkage assembly 26. It does not interfere with movement of the linkage assembly 26 as it moves between the fully extended and retracted positions of the slide-out section 12. However, one or both of the tabs 90 and 92 will engage the associated drive 40 and/or 42 pivot link in the event the linkage assembly 26 is forced to move in a retraction direction beyond the fully retracted position of the slide-out section 12 shown in FIG. 6. The tabs 90 and 92 will contact the drive 40 and/or pivot 42 links and thus interfere with and prevent further pivoting of linkage assembly 26.

Thus, as described above, the movement of the linkage assembly 26 is self-limited to the useful range of motion needed to move the slide-out section 12 between fully extended and retracted positions. The components used to effect movement of the slide-out section 12 are also used to lock and limit its movement. The slide-out mechanism of the present invention thus provides an integrated passive locking and travel limiting arrangement using the primary motive system without the need for additional secondary components. The slide-out mechanism disclosed thus provides cost, space and weight saving benefits arising from the elimination of such secondary components, as well as obvious the need for synchronization with the primary motive system and its controls.

FIG. 9 illustrates one of two slide-out mechanisms 124 according to another embodiment of the invention. Like the preceding embodiment, here there are two identical, but mirror image slide-out mechanisms mounted at the lateral sides of the slide-out section 112 so as to mount the slide-out section 112 to the vehicle 110 at the opposite side walls 120. The slide-out mechanism 124 has a linkage assembly 126 driven by a drive actuator 128. Here, the drive actuator 128 is a threaded drive screw and nut arrangement which causes an actuator member 160 to telescope in and out of a tubular housing 131. The drive screw and nut turn relative to another when a motor 133 is operated. The motor 133 being coupled to the screw and nut arrangement through a gear box 135 that provides the necessary gearing. The drive actuator 128 is pivotally mounted to the vehicle member 134 via bracket 164, which has a pin connection 166 allowing the drive actuator 128 to pivot. The actuator member 160, at the other end of the drive actuator 128, pivotally couples to the linkage assembly 126.

The linkage assembly 126 includes a drive link 140, a pivot link 142, a follower drive link 144, a follower pivot link 146, traveling tie links 150 and 151. The links are coupled together at pivots including a pair of stationary pivots 152 and 153, fixed pivots 154 and 155 and traveling pivots 156 and 157. The stationary pivots 152 and 153 are mounted to the vehicle via an upright member 134 and do not change position during operation of the slide-out mechanism 124. The fixed pivots 154 and 155 are secured to the vertical side wall of the slide-out section 112 via member 135 and move along with the slide-out section 112 as it is extended and retracted. The traveling pivots 156 and 157 are not mounted to, and are thus free to move relative to, the slide-out section 12 and the vehicle. The traveling pivots 156 and 157 travel in a path that is generally perpendicular to the travel path of the slide-out section 112. By the fixed pivots 154 and 155 being mounted to the slide-out section 112 and the stationary pivots 152 and 153 being mounted to the vehicle, the linkage assembly 126 serves to join the slide-out section 112 to the vehicle and transmits input drive forces to provide relative movement.

The drive actuator 128 is pivotally mounted to two tabs 101 and 102 extending down from the traveling tie links 150 and 151, are bend out to accommodate the drive actuator 128 as the linkage assembly travels as they extend between the traveling pivots 156 and 157. The pivot allow for pivotal movement of the linkage assembly 126 as the slide-out section is extended and retracted.

It should be appreciated that merely preferred embodiments of the invention have been described above. However, many modifications and variations to the preferred embodiments will be apparent to those skilled in the art, which will be within the spirit and scope of the invention. Therefore, the invention should not be limited to the described embodiments. To ascertain the full scope of the invention, the following claims should be referenced.

What is claimed is:

1. A slide-out mechanism for moving a slide-out section of a vehicle from a retracted position within an interior of the vehicle to an extended position outward of the vehicle interior, wherein the slide-out section has a floor, an end wall and side walls, the slide-out mechanism comprising:
a first pivot and a second pivot, one of said first and second pivots being movable with the slide-out section and the other being fixed in position relative to the vehicle;
a linkage assembly including a drive link pivotally coupled to a pivot link, the drive link having one end pivotally coupled to the first pivot and the pivot link having one end pivotally coupled to the second pivot;
a drive actuator coupled to the linkage assembly to impart a drive force to move the slide-out section between retracted and extended positions; and
wherein the drive actuator drives the drive link to pivot about the first pivot so that the linkage assembly drives the slide-out section to slide between the extended and retracted positions relative to the vehicle.

2. The slide-out mechanism of claim 1, wherein the first pivot and the drive actuator are mounted to the vehicle and the second pivot is mounted to one of the side walls of the slide-out section.

3. The slide-out mechanism of claim 1, wherein the drive actuator is a linear actuator having a linearly moveable drive member.

4. The slide-out mechanism of claim 3, wherein the linear actuator is pivotally mounted with respect to the drive link.

5. The slide-out mechanism of claim 1, further including a second pair of first and second pivots vertically spaced from the first and second pivots and wherein the linkage system further includes at least one tie link and a pair of follower drive and pivot links pivotally coupled together and to an associated one of the second pair of first and second pivots, wherein pivotal movement of the drive and pivot links is transferred to the follower drive and pivot links by the at least one tie link.

6. The slide-out mechanism of claim 5, wherein the at least one tie link is pivotally coupled to the drive and pivot links at one end and to the follower drive and pivot links at the other end.

7. The slide-out mechanism of claim 1, further including:
a catch fixedly mounted to the pivot link to move therewith;
a pivot block fixedly mounted to the drive link to move therewith; and
a drive pivot pivotally coupled to the drive actuator and the pivot block;
wherein the drive pivot engages the catch at a predetermined pivot angle between the drive and pivot links to prevent relative pivoting of the drive and pivot links beyond the predetermined pivot angle.

8. The slide-out mechanism of claim 7, wherein the drive pivot includes a lever member that abuts the catch when the drive and pivot links are at the predetermined pivot angle.

9. The slide-out mechanism of claim 7, wherein the pivot block has a retainer that allows relative movement of a mating feature of the drive pivot when the drive link is pivoted in one direction and fixes the position of the mating feature as the drive link is pivoted in the opposite direction.

10. The slide-out mechanism of claim 9, further including a spring operatively mounted between the pivot block and the drive pivot to bias against pivoting of the drive pivot.

11. The slide-out mechanism of claim 7, wherein the catch extends essentially perpendicularly from the pivot link.

12. The slide-out mechanism of claim 7, wherein the predetermined pivot angle corresponds to a fully extended position of the slide-out section.

13. The slide-out mechanism of claim 1, further including a travel stop mounted to the linkage assembly so as to permit pivoting of the linkage assembly to drive the slide-out section between fully retracted and extended positions and to interfere with at least one of the drive and pivot links to prevent relative pivoting of the drive and pivot links beyond that corresponding to one of the fully retracted and extended positions of the slide-out section.

14. The slide-out mechanism of claim 13, wherein the drive and pivot links are essentially co-linear when the slide-out section is in one of the fully extended and fully retracted positions.

15. The slide-out mechanism of claim 14, wherein the drive and pivot links are essentially co-linear when the slide-out section is fully retracted, and wherein the travel stop prevents further pivoting of the linkage system beyond that corresponding to the fully retracted position of the slide-out section.

16. The slide-out mechanism of claim 1, wherein there is a second assembly of said pair of first and second pivots, drive actuator and a linkage assembly such that two such assemblies are arranged in mirror image at opposite side walls of the slide-out section.

17. A slide-out mechanism for moving a slide-out section of a vehicle from a retracted position within an interior of the vehicle to an extended position outward of the vehicle interior, wherein the slide-out section has a floor, an end wall and side walls, the slide-out mechanism comprising:
a pair of first and second pivots, said second pivot being mounted to the slide-out section and the first pivot being fixed in position relative to the vehicle;
a linkage assembly including a drive link pivotally coupled to a pivot link, the drive link having one end pivotally coupled to the first pivot and the pivot link having one end pivotally coupled to the second pivot; and
a linear drive actuator mounted to the vehicle having a linearly movable drive member that is pivotally coupled to the drive link, the drive actuator driving the drive link to pivot about the first pivot so that the linkage assembly drives the slide-out section to slide between extended and retracted positions relative to the vehicle.

18. A slide-out mechanism for moving a slide-out section of a vehicle from a retracted position within an interior of the vehicle to an extended position outward of the vehicle interior, wherein the slide-out section has a floor, an end wall and side walls, the slide-out mechanism comprising:
a pair of first and second pivots;
a linkage assembly including a drive link pivotally coupled to a pivot link, the drive link having one end pivotally coupled to the first pivot and the pivot link having one end pivotally coupled to the second pivot;
a drive actuator, wherein one of the drive actuator and the first pivot are mounted to the vehicle and the second pivot is mounted to the slide-out section, the drive actuator driving the drive link to pivot about the first pivot so that the linkage assembly drives the slide-out section to slide between extended and retracted positions relative to the vehicle;
a catch fixedly mounted to the pivot link to move therewith;
a pivot block fixedly mounted to the drive link to move therewith; and
a drive pivot pivotally coupled to the drive actuator and the pivot block, the drive pivot engaging the catch at a predetermined pivot angle between the drive and pivot links to prevent relative pivoting of the drive and pivot links beyond the predetermined pivot angle.

19. A slide-out mechanism for moving a slide-out section of a vehicle from a retracted position within an interior of the vehicle to an extended position outward of the vehicle interior, wherein the slide-out section has a floor, an end wall and side walls, the slide-out mechanism comprising:
a pair of first and second pivots;
a linkage assembly including a drive link pivotally coupled to a pivot link, the drive link having one end pivotally coupled to the first pivot and the pivot link having one end pivotally coupled to the second pivot;
a drive actuator, wherein one of the drive actuator and the first pivot are mounted to the vehicle and the second pivot is mounted to the slide-out section, the drive actuator driving the drive link to pivot about the first pivot so that the linkage assembly drives the slide-out section to slide between extended and retracted positions relative to the vehicle;
a first travel stop arrangement having a catch fixedly mounted to the pivot link to move therewith that engages a member mounted to the drive link at a first predetermined pivot angle between the drive and pivot links to prevent relative pivoting of the drive and pivot links in a first direction beyond the first predetermined pivot angle; and
a second travel stop arrangement mounted to the linkage assembly to move therewith and to abut at least one of the drive and pivot links to prevent relative pivoting of the drive and pivot links in a second direction opposite the first direction beyond the second predetermined angle.
